(19) United States
(12) Patent Application Publication
(10) Pub. No.: US 2024/0257144 A1
(43) Pub. Date: Aug. 1, 2024

(54) INTELLIGENT ORDER FULFILLMENT AND DELIVERY

(71) Applicant: TOSHIBA GLOBAL COMMERCE SOLUTIONS, INC., Durham, NC (US)

(72) Inventors: Daniel R. GOINS, Wake Forest, NC (US); Susan W. BROSNAN, Raleigh, NC (US); Jessica SNEAD, Cary, NC (US); Patricia S. HOGAN, Raleigh, NC (US)

(21) Appl. No.: 18/163,232

(22) Filed: Feb. 1, 2023

(51) Int. Cl. G06Q 30/015; G06V 10/70; G06V 20/52

(52) U.S. Cl. CPC G06Q 30/015; G06V 10/70; G06V 20/52; G06V 2201/07

(57) ABSTRACT

Techniques for intelligent order fulfillment using sensor feedback are disclosed. These techniques include receiving data captured by a plurality of sensors during fulfillment of one or more customer orders. The techniques further include predicting one or more issues affecting order fulfillment success using the data captured by the plurality of sensors and one or more trained machine learning (ML) models, and identifying one or more actions to improve order fulfillment based on the predicted one or more issues.

### BACKGROUND

Monitoring, and improving, order fulfillment and delivery is very important for many businesses. Customer experiences are very difficult to monitor, and can have an outsized impact on the success of the business. A customer faced with a poor experience at a business (e.g., a restaurant, grocery store, or any other suitable business) may decline to frequent the business, provide negative feedback to others, and lead to decreased success for the business. Existing systems may rely on customer feedback to identify problems with order fulfillment (e.g., customer surveys or reviews), or in some cases, monitor particular order fulfillment metrics (e.g., order volume or throughput), and may attempt to improve customer satisfaction by responding to customer feedback with incentives (e.g., coupons or sales credits). But this is inefficient at identifying issues with order fulfilment, and insufficient to improve order fulfillment.

### BRIEF DESCRIPTION OF THE SEVERAL VIEWS OF THE DRAWINGS

FIG. 1A illustrates an environment for intelligent order fulfillment, according to one embodiment.

FIG. 1B illustrates a computing environment for intelligent order fulfillment, according to one embodiment.

FIG. 2 is a block diagram illustrating a prediction controller for intelligent order fulfillment, according to one embodiment.

FIG. 3 is a flowchart illustrating intelligent order fulfillment, according to one embodiment.

FIG. 4A illustrates using machine learning (ML) for intelligent order fulfillment using metrics, according to one embodiment.

FIG. 4B illustrates training an ML model for intelligent order fulfillment using metrics, according to one embodiment.

FIG. 5 is a flowchart illustrating intelligent order fulfillment using metrics, according to one embodiment.

### DETAILED DESCRIPTION

One or more techniques described herein provide a business with the ability to identify a wide variety of order fulfillment or delivery issues (e.g., with the businesses processes, employees, ergonomics, or any other suitable issues or problems) without the necessity of customer feedback or direct employee reporting. Through the use of sensors and sensor analytics (e.g., video monitoring and analytics) a large number of different aspects of order fulfillment and delivery can be monitored. This sensor data can be used to predict the success of ongoing order fulfillment (e.g., using one or more suitable trained machine learning (ML) models), to identify potential problem areas, and to suggest solutions to improve order fulfillment.

### Advantages of Intelligent Order Fulfillment

One or more embodiments disclosed herein have numerous technical advantages compared with prior solutions. For example, one or more techniques disclosed below use a trained ML model to analyze sensor data, predict order fulfillment issues, or both. Using a trained ML model to perform these predictions provides a significant technical advantage. For example, in an embodiment some aspects of order fulfillment can be individually analyzed using a specific rubric or algorithm with pre-defined rules. But this may be computationally expensive, because a very large number of rules would be needed and parsing and following the rules is computationally expensive. Further, using pre-defined rules would require this computationally expensive analysis be done at the time of the prediction, when a rapid response is likely to be needed (e.g., so that order fulfillment prediction can be provided and used for improvement). Predicting order fulfillment issues and improvements automatically using a trained ML model, by contrast, is significantly less computationally expensive at the time the prediction generated. For example, the ML model can be trained during an offline training phase, when rapid response is not necessary and computational resources are readily available. The trained ML model can then operate rapidly, and computationally cheaply, during an online inference phase to perform the prediction(s).

As another example, automatically predicting order fulfillment issues and improvements provides for a more accurate and well-defined result. In an embodiment, a business administrator could manually review sensor data and attempt to predict what issues affect order fulfillment success and how order fulfillment could be improved. But this leaves the risk of human error, and a lack of certainty in the accuracy of the review. Predicting changes to order fulfillment (e.g., using a trained ML model, defined automated rules or metrics, or both) can both lessen the risk of human error, and provide more certainty in the level of accuracy of the prediction. Further, the prediction can itself be reviewed and refined by a business administrator. This provides a starting point for the business administrator with a more certain level of accuracy, and reduces the burden on the business administrator to generate the prediction themselves. This is especially true because the administrator will almost certainly not have access or knowledge of all of the historical satisfaction data, described further below, that can be considered at instant using one or more of the automated techniques described below.

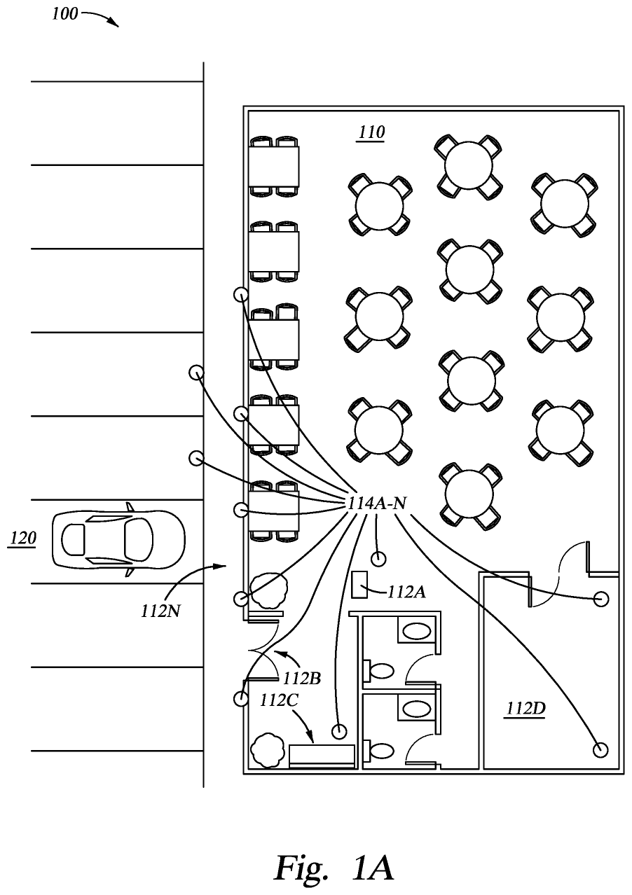

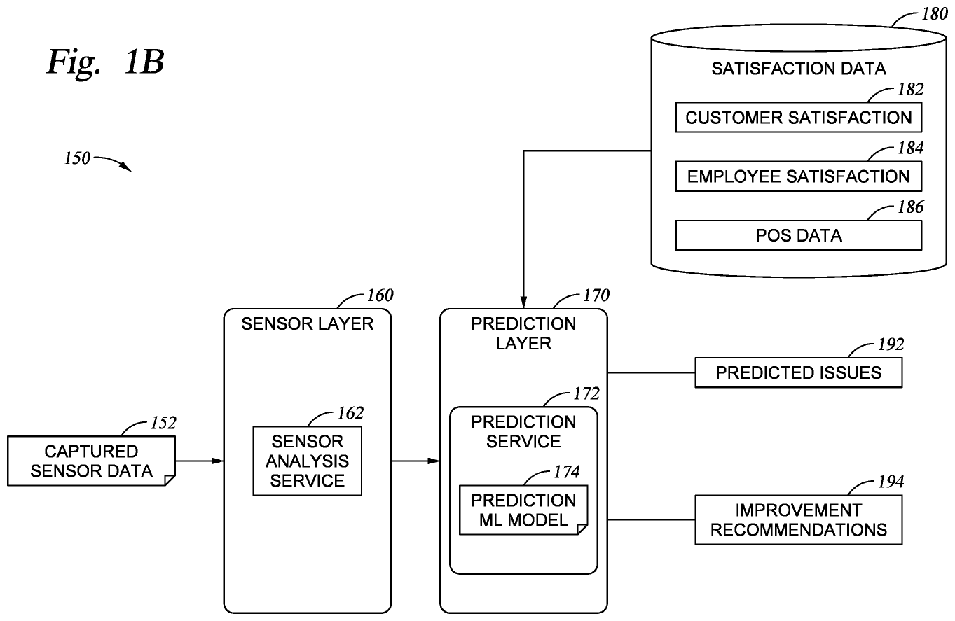

FIG. 1A illustrates an environment 100 for intelligent order fulfillment, according to one embodiment. The environment 100 includes a business location 110 (e.g., a restaurant) and one or more customer interaction points 120 (e.g., a parking lot for delivery of items from the business). The environment 100 further includes a number of different physical locations for monitoring 112A-N. These physical locations can include, for example, a payment area 112A (e.g., an area including point of sale (POS) systems, or otherwise suitable for a customer to pay for, or receive, purchased items), an entry and exit area 112B, a customer waiting area 112C, a kitchen area 112D (e.g., for a restaurant), or an exterior customer pathway 112N (e.g., a pathway for a customer to enter the business from the customer's mode of transportation). These are merely examples, and the environment 100 can include any number of suitable physical locations for monitoring.

The environment 100 can further include a number of sensors 114A-N. In an embodiment, these sensors are used to monitor order fulfilment, as discussed below with regard to FIGS. 1B-5. For example, the sensors 114A-N can include cameras (e.g., still or video cameras), microphones (e.g., to detect sounds or speech occurring during order fulfillment), weight or position sensors (e.g., to detect a parked vehicle or a customer waiting), motion sensors (e.g., to detect customer or employee movement), radio frequency identification (RFID) sensors (e.g., to detect employee locations or movement), or any other suitable sensors. In an embodiment, data is collected from these sensors and used to predict potential problems relating to order fulfillment, and to identify potential solutions to improve order fulfillment.

FIG. 1B illustrates a computing environment 150 for intelligent order fulfillment, according to one embodiment. In an embodiment, captured sensor data 152 is provided to a sensor layer 160. For example, one or more sensors (e.g., the sensors 114A-N illustrated in FIG. 1A) may be used to capture data reflecting order fulfillment. The sensors can include cameras (e.g., still or video cameras), weight or position sensors (e.g., to detect a parked vehicle or a customer waiting), motion sensors (e.g., to detect customer or employee movement), radio frequency identification (RFID) sensors (e.g., to detect employee locations or movement), or any other suitable sensors. The sensor data 152 can include captured image data (e.g., from cameras), captured audio data (e.g., from microphones), weight or position data (e.g., from weight or position sensors), motion data (e.g., from motion sensors), RFID data (e.g., from RFID sensors), or any other suitable sensor data.

For example, the captured sensor data 152 could include captured image data reflecting employee operation in various locations within a business location (e.g., a restaurant). This include images reflecting the position of employees preparing food in a restaurant (e.g., in the kitchen 112D illustrated in FIG. 1A), images reflecting the position of employees handing items to customers and receiving payment in a payment area (e.g., in the payment area 112A illustrated in FIG. 1A), images reflecting customers in a customer waiting area (e.g., the customer waiting area 112C illustrated in FIG. 1A) or an exterior area (e.g., the exterior customer pathway 112N)), or any other suitable location. This is merely an example, and the capture sensor data 152 can reflect data from any suitable sensor(s).

In an embodiment, the captured sensor data 152 is provided to the sensor layer 160 using a suitable communication network. For example, the captured sensor data 152 can be captured by sensors connected to a communication network (e.g., internet of things (IoT) devices or any other suitable computing devices) and transferred to the sensor layer 160 using the communication network. This can include any suitable communication network, including the Internet, a wide area network, a local area network, or a cellular network, and can use any suitable wired or wireless communication technique (e.g., WiFi or cellular communication). This is merely one example, and the captured sensor data 152 can be provided to the sensor layer 160 using any suitable technique (e.g., using storage medium or through a wired or wireless transmission from the camera to the computing device).

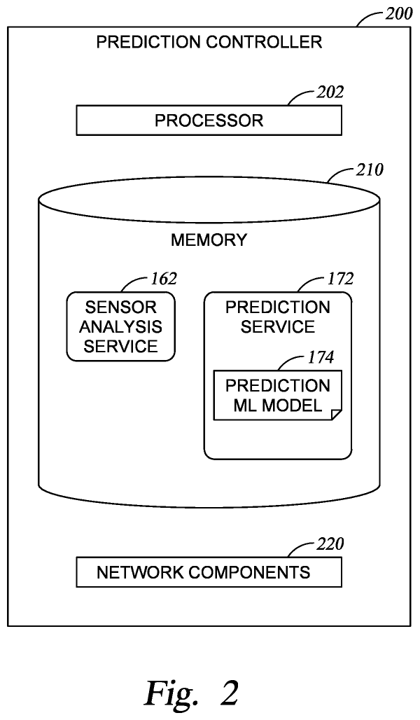

The sensor layer 160 includes a sensor analysis service 162, which facilitates analysis of the captured sensor data. For example, as discussed below with regard to FIG. 2, the sensor analysis service 162 can be computer software service implemented in a suitable controller (e.g., the prediction controller 200 illustrated in FIG. 2) or combination of controllers. In an embodiment the sensor layer 160 includes a sensor analysis service 162, can be implemented using any suitable combination of physical compute systems, cloud compute nodes and storage locations, or any other suitable implementation. For example, the sensor layer 160 could be implemented using a server or cluster of servers. As another example, the sensor layer 160 can be implemented using a combination of compute nodes and storage locations in a suitable cloud environment. For example, one or more of the components of the sensor layer 160 can be implemented using a public cloud, a private cloud, a hybrid cloud, or any other suitable implementation.

As discussed above, in an embodiment the sensor analysis service 162 facilitates analysis of the captured sensor data 152. For example, the sensor analysis service 162 can include one or more ML models (e.g., trained, supervised ML models) to analyze or transform the captured sensor data 152. This can include, for example, a suitable computer vision ML model (e.g., a DNN, support vector machine (SVM), or any other suitable ML model) used for image recognition with captured image data. In an embodiment, the sensor analysis service 162 can use an ML model trained to receive images in the captured sensor data 152 and recognize or detect various characteristics of the order fulfillment depicted in the image. This can include, for example, identifying an order as it is being fulfilled (e.g., items being prepared or delivered to customers), identifying employees undertaking various tasks, identifying customer positions or actions (e.g., entering or leaving a business location), and any other suitable analysis. Image recognition using a suitable computer vision ML model is merely one example, however, and the sensor analysis service 162 can use any suitable ML model (e.g., an unsupervised or supervised ML model).

Further, in an embodiment, the sensor analysis service 162 can use multiple ML models trained to analyze or transform various types of captured sensor data 152. For example, one ML model could be trained to use computer vision techniques to identify inanimate objects in captured images (e.g., items being prepared or delivered to customers), another ML model could be trained to identify human personnel, another ML model could be trained to use sentiment analysis to predict the satisfaction of employees or customers, and another ML model could be used to identify characteristics of audio captured during order fulfillment. In some aspects, these different models may be used together to produce a prediction (e.g., using ensemble machine learning). This is merely an example, and the sensor analysis service 162 could instead be trained to use data from multiple sources (e.g., captured sensor data 152 from multiple sources), together, to analyze order fulfillment.

As discussed above, in an embodiment the sensor analysis service 162 can use one or more suitable ML models to analyze or transform the captured sensor data 152. But this is one example. Alternatively, or in addition, the sensor analysis service 162 can use additional techniques (e.g., rules, thresholds, algorithmic analysis, or any other suitable technique) to analyze or transform the captured sensor data 152. For example, the captured sensor data 152 can include position or RFID sensors, and the sensor analysis service 162 can use suitable rules to identify the locations of items or personnel using the data from the position or RFID sensors.

In an embodiment, the sensor layer 160 provides analyzed or transformed sensor data to a prediction layer 170. For example, the sensor layer 160 can use one or more ML models to analyze the captured sensor data 152 (e.g., analyze images or sounds captured during order fulfillment using sensors), and can provide the results of the analysis to the prediction layer 170. Alternatively, or in addition, the sensor layer 160 can pass the captured sensor data 152 (e.g., the entirety of the captured sensor data 152 or any suitable portion(s) of the captured sensor data) through to the prediction layer.

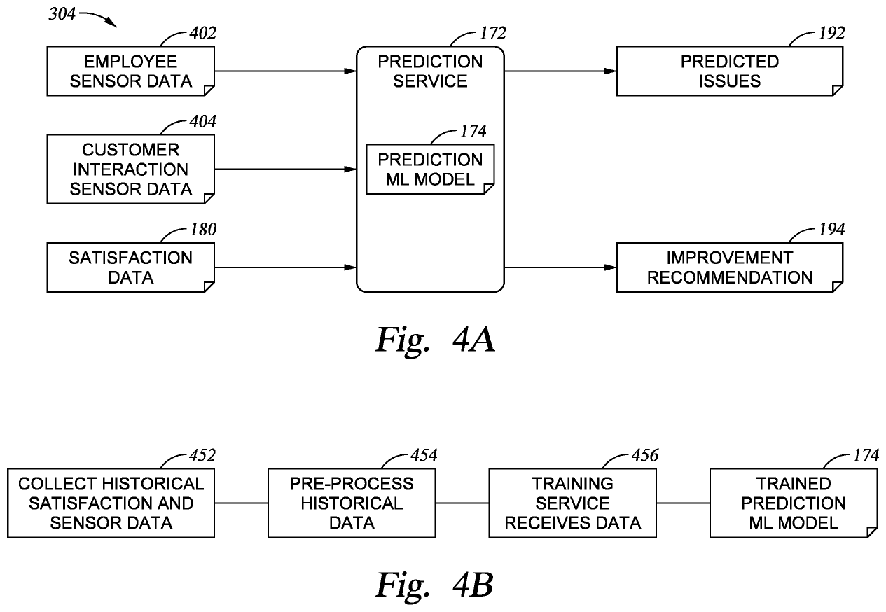

The prediction layer 170 includes a prediction service 172 and a prediction ML model 174. In an embodiment, the prediction service 172 facilitates prediction of issues impacting the current state of order fulfillment for a business (e.g., the success or failure of order fulfillment or particular aspects of order fulfillment). For example, the prediction service 172 can use the prediction ML model 174 to determine predicted issues 192 (e.g., a prediction of issues affecting the success or failure of order fulfillment). This is discussed further below with regard to FIG. 4A. For example, the predicted issues could include staffing levels, staffing distribution, order fulfillment flow, customer interaction issues (e.g., parking or point of sale issues), or any other suitable issues. In an embodiment, the predicted issues can include predicted negative issues (e.g., issues predicted to decrease customer or employee satisfaction), predicted positive issues (e.g., issues predicted to increase customer or employee satisfaction), or both.

As discussed below with regard to FIG. 2, the prediction service 172 can be computer software service implemented in a suitable controller (e.g., the prediction controller 200 illustrated in FIG. 2) or combination of controllers. In an embodiment the prediction layer 170, and the prediction service 172, can be implemented using any suitable combination of physical compute systems, cloud compute nodes and storage locations, or any other suitable implementation. For example, the prediction layer 170 could be implemented using a server or cluster of servers. As another example, the prediction layer 170 can be implemented using a combination of compute nodes and storage locations in a suitable cloud environment. For example, one or more of the components of the prediction layer 170 can be implemented using a public cloud, a private cloud, a hybrid cloud, or any other suitable implementation.

As discussed above, the prediction layer 170 uses the analyzed captured sensor data 152 to predict issues affecting the success of order fulfillment. In an embodiment, however, the captured sensor data 152 detected by the sensor layer 160 are not sufficient to allow the prediction layer 170 to accurately predict issues affecting the success of order fulfillment. For example, merely observing order fulfillment using sensors may not be sufficient to accurately predict what issues are making order fulfillment less, or more, successful for customers or employees.

In an embodiment, the prediction layer 170 can further receive, and use, satisfaction data 180. For example, the satisfaction data 180 can include customer satisfaction data 182 (e.g., customer surveys, customer reviews (e.g., through web sites, social media applications, or any other suitable channel), or any other suitable reflection of customer satisfaction) and employee satisfaction data 184 (e.g., employee surveys, employee reviews (e.g., through web sites, social media applications, or any other suitable channel), or any other suitable reflection of employee satisfaction).

Further, the satisfaction data can include point of sale (POS) data 186. For example, the POS data 186 can reflect data captured at a POS system for a business. This can include sales volumes and trends, gratuities collected, options selected at a POS system, and any other suitable POS data. In an embodiment, the satisfaction data 180 has had any personally identifying customer or employee information removed.

In an embodiment, the satisfaction data 180 is provided to the prediction layer 170 using a suitable communication network. For example, the satisfaction data 180 can be stored in one or more suitable electronic databases (e.g., a relational database, a graph database, or any other suitable database) or other electronic repositories (e.g., a cloud storage location, an on-premises network storage location, or any other suitable electronic repository). The satisfaction data 180 can be provided from the respective electronic repositories to the prediction layer 170 using any suitable communication network, including the Internet, a wide area network, a local area network, or a cellular network, and can use any suitable wired or wireless communication technique (e.g., WiFi or cellular communication).

As discussed above, in an embodiment, the prediction service 172 uses the prediction ML model 174 to predict issues affecting the success of order fulfillment. For example, the prediction ML model 174 can be a suitable supervised ML model (e.g., a DNN) trained to generate predicted issues 192. In an embodiment, the prediction ML model 174 can be selected based on initial analysis of the input data (e.g., the captured sensor data 152, analyzed captured sensor data generated by the sensor layer 160, and satisfaction data 180). In an embodiment, a basic technique can be initially selected (e.g., logistic regression), data can be converted to a numerical format, and based on initial analysis data transformation and ML techniques can be chosen. This is merely an example, and any suitable supervised, or unsupervised, techniques can be used.

Further, in an embodiment, the prediction layer 170 can generate one or more improvement recommendations 194. For example, the predicted issues 192 can identify issues that are predicted to impact success for order fulfillment for a business (e.g., a restaurant). The improvement recommendation 194 can identify recommended changes to improve order fulfillment. For example, the improvement recommendation 194 can recommend modified staffing levels (e.g., more employees, different employee assignments, etc.), modified order fulfillment flow, modified customer interactions (e.g., messaging to customers), or any other suitable recommendations. In an embodiment, the prediction ML model 174 can generate these improvements based on identifying the features most impactful in the predicted issues 192. Alternatively, or in addition, another ML model or an algorithmic technique can be used to analyze the prediction ML model 174 and identify features impacting the predicted issues 192, and this can be used to generate the improvement recommendation 194. For example, a feature relating to kitchen staffing could be identified as impactful in the prediction ML model, and the improvement recommendation could recommend changing this staffing. This is merely an example.

In an embodiment, the predicted issues 192, the improvement recommendation 194, or both, can be used to continuously train the prediction ML model 174. For example, prior improvement recommendations 194 can be correlated with newly captured sensor data 152, and used to identify the success or failure of the improvement recommendation. This can then be used to update training of the prediction ML model 174 (e.g., periodically, as scheduled, or in real-time if compute resources are available).

FIG. 1B illustrates the prediction service 172 using one or more suitable prediction ML models 174 to generate the predicted issues 192 and improvement recommendation 194. This is merely an example. Alternatively, or in addition, the prediction service 172 can use one or more unsupervised ML models, one or more rules-based techniques (e.g., not involving an ML model), or any other suitable technique(s) to generate the predicted issues 192 or improvement recommendation 194.

FIG. 2 is a block diagram illustrating a prediction controller for intelligent order fulfillment, according to one embodiment. The controller 200 includes a processor 202, a memory 210, and network components 220. The memory 210 may take the form of any non-transitory computer-readable medium. The processor 202 generally retrieves and executes programming instructions stored in the memory 210. The processor 202 is representative of a single central processing unit (CPU), multiple CPUs, a single CPU having multiple processing cores, graphics processing units (GPUs) having multiple execution paths, and the like.

The network components 220 include the components necessary for the controller 200 to interface with a suitable communication network (e.g., a communication network interconnecting various components of the computing environment 100 illustrated in FIG. 1B, or interconnecting the computing environment 100 with other computing systems). For example, the network components 220 can include wired, WiFi, or cellular network interface components and associated software. Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory.

The memory 210 generally includes program code for performing various functions related to use of the prediction controller 200. The program code is generally described as various functional “applications” or “modules” within the memory 210, although alternate implementations may have different functions and/or combinations of functions. Within the memory 210, the sensor analysis service 162 facilitates analyzing or transforming captured sensor data (e.g., captured images and other captured sensor data). The prediction service 172 facilitates predicting issues affecting the success of order fulfillment, using the prediction ML model 174.

While the controller 200 is illustrated as a single entity, in an embodiment, the various components can be implemented using any suitable combination of physical compute systems, cloud compute nodes and storage locations, or any other suitable implementation. For example, the controller 200 could be implemented using a server or cluster of servers. As another example, the controller 200 can be implemented using a combination of compute nodes and storage locations in a suitable cloud environment. For example, one or more of the components of the controller 200 can be implemented using a public cloud, a private cloud, a hybrid cloud, or any other suitable implementation.

Although FIG. 2 depicts the sensor analysis service 162, the prediction service 172, and the prediction ML model 174, as being mutually co-located in memory 210, that representation is also merely provided as an illustration for clarity. More generally, the controller 200 may include one or more computing platforms, such as computer servers for example, which may be co-located, or may form an interactively linked but distributed system, such as a cloud-based system, for instance. As a result, processor 202 and memory 210 may correspond to distributed processor and memory resources within the computing environment 100. Thus, it is to be understood that any, or all, of the sensor analysis service 162, the prediction service 172, and the prediction ML model 174 may be stored remotely from one another within the distributed memory resources of the computing environment 100.

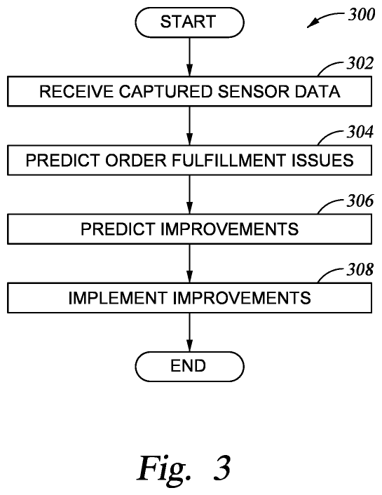

FIG. 3 is a flowchart 300 illustrating intelligent order fulfillment, according to one embodiment. At block 302 a sensor analysis service (e.g., the sensor analysis service 162 illustrated in FIGS. 1B and 2) receives captured sensor data. For example, as discussed above in relation to FIG. 1A, one or more sensors (e.g., the sensors 114A-N) can capture data reflecting order fulfillment. These sensors can include, for example, cameras (e.g., still or video cameras), microphones (e.g., to detect sounds or speech occurring during order fulfillment), weight or position sensors (e.g., to detect a parked vehicle or a customer waiting), motion sensors (e.g., to detect customer or employee movement), RFID sensors (e.g., to detect employee locations or movement), or any other suitable sensors. At block 302, the sensor analysis service receives data from these sensors.

At block 304, a prediction service (e.g., the prediction service 172 illustrated in FIGS. 1B and 2) predicts order fulfillment issues. As discussed above in relation to FIG. 1B, in an embodiment the prediction service uses the captured sensor data to predict issues affecting the success of ongoing order fulfillment (e.g., from the customer or employee perspective). For example, the prediction service can use a suitable ML model (e.g., the prediction ML model 174 illustrated in FIGS. 1B and 2) to generate a prediction (e.g., the predicted issues 192 illustrated in FIG. 1B) of issues affecting the success of order fulfillment. This is merely an example, and as discussed above in relation to FIG. 1B the prediction service can use any suitable technique.

At block 306, the prediction service predicts improvements. As discussed above in relation to FIG. 1B, in an embodiment the prediction service uses the captured sensor data to predict improvements for order fulfillment. For example, the prediction service can use a suitable ML model (e.g., the prediction ML model 174 illustrated in FIGS. 1B and 2) to generate an improvement recommendation (e.g., the improvement recommendation 194 illustrated in FIG. 1B). This is merely an example, and as discussed above in relation to FIG. 1B the prediction service can use any suitable technique.

In an embodiment, predicted improvements can be provided with a suitable reporting system or user interface. For example, a prediction service could generate a user interface identifying periodic (e.g., daily, weekly, monthly, etc.) analysis of the predicted issues affecting order fulfillment success for one or more business locations. The user interface could identify issues order fulfillment success, along with predicted improvements (e.g., as discussed below with regard to block 308) using a textual list, a graphical display, an audio description, or any other suitable interface.

At block 308, a business implements the improvements. For example, the prediction service can predict staffing changes, order fulfillment process or flow changes, and any other suitable changes that are predicted to improve order fulfillment success. The business can implement these changes.

Further, in an embodiment, a business can identify which improvements have been implemented. For example, a suitable user interface could be provided and a business could identify which of the suggested improvements have been implemented, along with any additional changes. The prediction service can then track ongoing order fulfilment to identify the success in implementation of the improvement (e.g., how frequently is the improvement actually implemented) and the success in order fulfillment following the improvement. As discussed further below, this can be used for ongoing training of a suitable ML model.

Improvements can also be propagated to other businesses or other locations. For example, a business could operate multiple locations (e.g., a multi-location restaurant or store). The identified improvements for one location could be propagated to additional locations. Further, the prediction service can identify which locations are likely to be most suitable to implement the predicted improvements. This could be based on various similarities or differences between locations (e.g., geographic similarities, service volume similarities, staffing similarities, or any other similarities). A user could choose to implement improvements at these additional locations.

While FIG. 3 focuses on identifying customer satisfaction and improvements to increase customer satisfaction, one or more of these techniques can also be used to improve employee satisfaction. For example, employee satisfaction could be measured using employee feedback, retention rates, sentiment analysis of images of employees, or using any other suitable technique. The prediction service can identify improvements to increase employee satisfaction (e.g., using a suitable trained ML model) and a business could implement these improvements. Further, ongoing feedback can be used to improve the employee satisfaction predictions and suggest additional improvements.

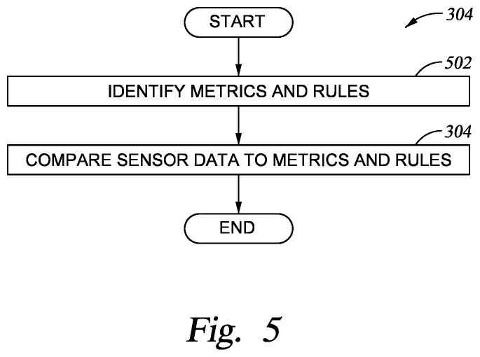

FIG. 4A illustrates using ML for intelligent order fulfillment using metrics, according to one embodiment. In an embodiment, FIG. 4A corresponds with one embodiment of block 304 illustrated in FIG. 3, above, in which a prediction ML model is used. As discussed below, FIG. 5 corresponds with another embodiment of block 304 in which a prediction ML model is not used. A prediction service 172, as discussed above in relation to FIGS. 1B-2, is associated with a prediction ML model 174. For example, as illustrated the prediction service 172 uses the prediction ML model 174 to generate predicted issues 192 (e.g., to predict issues affecting order fulfillment success).

In an embodiment, the prediction service 172 uses multiple types of data to generate the predicted issues 192, using the prediction ML model 174. For example, the prediction service 172 can use a variety of sensor data (e.g., the captured sensor data 152 illustrated in FIG. 1B). As one example, the prediction service uses employee sensor data 402 and customer interaction sensor data 404.

In an embodiment, the employee sensor data 402 includes sensor data describing employee location or behavior. This can include camera data, RFID data, audio data, and any other suitable sensor data. Further, in an embodiment, the customer interaction sensor data 404 includes data describing interactions with customers (e.g., payment by customers, waiting by customers, handover of goods to customers, and any other customer related customer sensor data). This can include camera data, audio data, motion sensor data, and any other suitable sensor data. Further, in an embodiment, either (or both) of the employee sensor data 402 and customer interaction sensor data 404 have been analyzed or transformed prior to being used by the prediction service 172 (e.g., using the sensor layer 160 illustrated in FIG. 1B).

Further, in an embodiment the employee sensor data includes satisfaction data 180. As described above in relation to FIG. 1B, the satisfaction data 180 can include customer satisfaction data, employee satisfaction data, or any other suitable satisfaction data. In an embodiment, the satisfaction data is collected from customers, employees, or other sources, rather than through sensors used during order fulfillment.

In an embodiment, the prediction service 172 uses the satisfaction data 180 for ongoing training of the prediction ML model 174. For example, because training the prediction ML model 174 may be computationally expensive, the prediction service can train the prediction ML model 174 at suitable intervals (e.g., hourly, daily, weekly) or based on triggering events (e.g., after a threshold number of new observations are received, upon request from an administrator, or at any other suitable interval). Alternatively, the prediction service 172 does not receive the satisfaction data 180. In this example, the satisfaction data 180 is used to train the prediction ML model (e.g., as discussed below in relation to FIG. 4B) but is not used for inference (e.g., for generating the predicted issues 192).

In an embodiment, the prediction ML model 174 further generates one or more improvement recommendations 194. As discussed above in relation to blocks 306 and 308 illustrated in FIG. 3, in an embodiment the prediction service 172 can predict staffing changes, order fulfillment process or flow changes, and any other suitable changes that are predicted to improve order fulfillment success.

FIG. 4B illustrates training an ML model for intelligent order fulfillment using metrics, according to one embodiment. This is merely an example, and in an embodiment a suitable unsupervised technique could be used (e.g., without requiring training). At block 452, a training service (e.g., a human administrator or a software or hardware service) collects historical satisfaction and sensor data. For example, a prediction service (e.g., the prediction service 172 illustrated in FIGS. 1B-2) can be configured to act as the training service and collect previously captured sensor data, along with historical satisfaction data. This is merely an example, and any suitable software or hardware service can be used (e.g., a dedicated training service).

In an embodiment, the historical satisfaction data includes historical records of the satisfaction data 180 illustrated in FIG. 1B. This can include customer satisfaction data 182 (e.g., customer surveys, customer reviews (e.g., through web sites, social media applications, or any other suitable channel), or any other suitable reflection of customer satisfaction) and employee satisfaction data 184 (e.g., employee surveys, employee reviews (e.g., through web sites, social media applications, or any other suitable channel), or any other suitable reflection of employee satisfaction). The satisfaction data can further include historical POS data 186, reflecting POS inputs and trends. In an embodiment, POS trends may provide a more accurate snapshot of customer satisfaction than surveys themselves-increasing sales or gratuities may reflect customer satisfaction, regardless of feedback provided by customers themselves.

At block 454, the training service (or other suitable service) pre-processes the collected historical data. For example, the training service can create feature vectors reflecting the values of various features, for each collected sensor or satisfaction data. At block 456, the training service receives the feature vectors and uses them to train a trained prediction ML model 174.

In an embodiment, the pre-processing and training can be done as batch training. In this embodiment, all data is pre-processed at once (e.g., all historical wound image data and additional wound data), and provided to the training service at block 456. Alternatively, the pre-processing and training can be done in a streaming manner. In this embodiment, the data is streaming, and is continuously pre-processed and provided to the training service. For example, it can be desirable to take a streaming approach for scalability. The set of training data may be very large, so it may be desirable to pre-process the data, and provide it to the training service, in a streaming manner (e.g., to avoid computation and storage limitations). Further, in an embodiment, a federated learning approach could be used in which multiple business entities contribute to training a shared model.

FIG. 5 is a flowchart illustrating intelligent order fulfillment using metrics, according to one embodiment. In an embodiment, FIG. 5 corresponds with another embodiment relating to block 304 illustrated in FIG. 3. At block 502 a prediction service (e.g., the prediction service 172 illustrated in FIGS. 1B-2) identifies metrics and rules. In one embodiment, as discussed above in relation to FIGS. 4A-B, the prediction service uses a suitable ML model to predict issues affecting order fulfillment success. Alternatively, or in addition, the prediction service uses metrics and rules to predict issues affecting order fulfillment success. In an embodiment, the metrics, rules, or both can be dynamically retrieved from a suitable repository (e.g., during operation), can be determined prior to operation (e.g., during a design phase), or can be identified from any other suitable source.

Further, in an embodiment, the metrics, rules, or both can be generated based on historical satisfaction and sensor data. For example, historical trends in customer and employee satisfaction can be correlated with corresponding sensor data, and used to create rules and metrics to predict issues affecting order fulfillment success. This can be done manually (e.g., by a human designer or administrator) or automatically (e.g., using automated heuristics). Further, in an embodiment, a suitable ML model can be used. For example, instead of (or in addition to) using an ML model to predict issues affecting order fulfillment success, as discussed above in relation to FIGS. 4A-B, an ML model can be used to generate metrics, rules, or both, and then the metrics and rules can be used to predict issues affecting order fulfillment success. Just as discussed in relation to FIGS. 4A-B, this can be any suitable ML model (e.g., a supervised ML model trained to generate metrics, rules, or both).

In an embodiment, a wide variety of metrics or rules can be used. This can include time to order, customer wait time, order pickup time, order delivery time, number of orders, frequency that a customer must physically enter the business (e.g., as opposed to remaining in the customer's vehicle), metrics on packing and assembling order (e.g., the frequency that condiments, utensils, side items, or other items are included or left out of orders), metrics on customer complaints (e.g., which complaints are most frequent), metrics on item replacement (e.g., following an error), customer transportation metrics (e.g., available parking spaces), or any other suitable metrics. Metrics can also include order information, including order size, average number of items per order, average number of items per order for a given time of day, average number of errors (e.g., as a fraction of total orders), number of customer orders (e.g., as opposed to pre-designed orders), or other suitable order information. These are merely examples, and any suitable metrics can be used.

Further, metrics can reflect apparent satisfaction of employees or customers. For example, a suitable ML model could be used to perform sentiment analysis on customer or employee images to identify apparent customer or employee satisfaction. As another example, a suitable ML model could use natural language processing (NLP) to identity the content of written or spoken customer feedback or communication.

In an embodiment, one or more of these metrics can also be used as features for a trained ML model (e.g., as discussed above in relation to FIGS. 4A-B). A data scientist could identify a variety of these metrics as features for the trained ML model, and could generate a training data set reflecting values for these features. The ML model could then be trained to infer issues affecting order fulfillment success based on sensor data, using these features.

At block 504, the prediction service compares sensor data to metrics and rules. For example, a metric or rule could identify that a particular average wait time for customers affects order fulfillment success. The prediction service could compare average wait times (e.g., as identified using sensor data) to this metric or rule to predict order fulfillment success. As another example, a metric or rule could identify that a frequency of forgetting particular items during order fulfillment (e.g., utensils or condiments) affects order fulfillment success (e.g., forgetting to deliver utensils or condiments at a relatively high rate predicts decreased success). The prediction service could identify the actual rate of forgetting these items, using sensors, and could compare this rate to the metric or rule to identify issues predicted to affect order fulfillment success.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications (e.g., a sensor analysis service 162, prediction service 172, or both, as illustrated in FIG. 1B) or related data available in the cloud. For example, the sensor analysis service 162, prediction service 172, or both, could execute on a computing system in the cloud and analyze sensor data and predict order fulfillment success. In such a case, the sensor analysis service 162, prediction service 172, or both, could analyze and store sensor data and prediction data at a storage location in the cloud. [Doing so allows a user to access this information from any computing system attached to a network connected to the cloud (e.g., the Internet).

While the foregoing is directed to embodiments of the present disclosure, other and further embodiments of the disclosure may be devised without departing from the basic scope thereof, and the scope thereof is determined by the claims that follow.

What is claimed is:

1. A method comprising:
receiving data captured by a plurality of sensors during fulfillment of one or more customer orders;
predicting one or more issues affecting order fulfillment success using the data captured by the plurality of sensors and one or more trained machine learning (ML) models; and
identifying one or more actions to improve order fulfillment based on the predicted one or more issues.

2. The method of claim 1, wherein a first ML model of the one or more trained ML model is trained to predict the one or more issues based on data captured by the plurality of sensors.

3. The method of claim 2, wherein the first ML model is trained using a plurality of satisfaction data reflecting historical customer satisfaction with order fulfillment and corresponding sensor data.

4. The method of claim 3, wherein the satisfaction data comprise point of sale (POS) data captured from point of sale systems during historical fulfillment of customer orders.

5. The method of claim 2, wherein a second ML model of the one or more trained ML models is trained to analyze the data captured by the plurality of sensors, and wherein the first ML model uses output from the second ML model.

6. The method of claim 5,
wherein the data captured by the plurality of sensors comprises image data captured during fulfillment of the one or more customer orders, and
wherein the second ML model comprises a computer vision ML model trained to recognize one or more objects in the image data.

7. The method of claim 6, wherein the one or more actions to improve order fulfillment are further identified using at least one of the one or more trained ML models.

8. The method of claim 2, further comprising:
modifying order fulfillment for customers based on the identified one or more actions.

9. The method of claim 1, wherein the sensors comprise a plurality of cameras capturing image data during the fulfillment of the one or more customer orders.

10. The method of claim 1, wherein the predicted one or more issues affecting order fulfillment success are predicted to affect at least one of: (i) customer satisfaction or (ii) employee satisfaction relating to order fulfillment.

11. A system, comprising:
a processor; and
a memory having instructions stored thereon which, when executed on the processor, performs operations comprising:
receiving data captured by a plurality of sensors during fulfillment of one or more customer orders;
predicting one or more issues affecting order fulfillment success using the data captured by the plurality of sensors and one or more trained machine learning (ML) models; and
identifying one or more actions to improve order fulfillment based on the predicted one or more issues.

12. The system of claim 11, wherein a first ML model of the one or more trained ML model is trained to predict the one or more issues based on data captured by the plurality of sensors.

13. The system of claim 12, wherein the first ML model is trained using a plurality of satisfaction data reflecting historical customer satisfaction with order fulfillment and corresponding sensor data.

14. The system of claim 12, wherein a second ML model of the one or more trained ML models is trained to analyze the data captured by the plurality of sensors, and wherein the first ML model uses output from the second ML model.

15. The system of claim 14,
wherein the data captured by the plurality of sensors comprises image data captured during fulfillment of the one or more customer orders, and
wherein the second ML model comprises a computer vision ML model trained to recognize one or more objects in the image data.

16. A non-transitory computer-readable medium having instructions stored thereon which, when executed by a processor, performs operations comprising:
receiving data captured by a plurality of sensors during fulfillment of one or more customer orders;
predicting one or more issues affecting order fulfillment success using the data captured by the plurality of sensors and one or more trained machine learning (ML) models; and
identifying one or more actions to improve order fulfillment based on the predicted one or more issues.

17. The non-transitory computer-readable medium of claim 16, wherein a first ML model of the one or more trained ML model is trained to predict the one or more issues based on data captured by the plurality of sensors.

18. The non-transitory computer-readable medium of claim 17, wherein the first ML model is trained using a plurality of satisfaction data reflecting historical customer satisfaction with order fulfillment and corresponding sensor data.

19. The non-transitory computer-readable medium of claim 17, wherein a second ML model of the one or more trained ML models is trained to analyze the data captured by the plurality of sensors, and wherein the first ML model uses output from the second ML model.

20. The non-transitory computer-readable medium of claim 19,
wherein the data captured by the plurality of sensors comprises image data captured during fulfillment of the one or more customer orders, and
wherein the second ML model comprises a computer vision ML model trained to recognize one or more objects in the image data.
